(19) United States
(12) Patent Application Publication
(10) Pub. No.: US 2009/0248709 A1
(43) Pub. Date: Oct. 1, 2009

(54) Evaluating Associations Among Entities

(76) Inventors: Oded Fuhrmann, Zichron Yaakov (IL); Dan Pelleg, Haifa (IL)

Correspondence Address: Century IP Group, Inc. [IBM IL];c/o IBM CORPORATION, T.J. WATSON RESEARCH CENTER, P.O. BOX 218, YORKTOWN HEIGHTS, NY, 10598, US

(21) Appl. No.: 12/055,330

(22) Filed: Mar. 26, 2008

(51) Int. Cl. G06F 17/30

(52) U.S. Cl. 707/100; 707/E17.044

(57) ABSTRACT

A method for monitoring associations between a plurality of entities comprises representing a relationship between a first entity and a second entity as an edge that connects a first node to a second node, wherein the first node and the second node respectively represent said first entity and said second entity; and assigning a weight value to said edge based on an association level detected between the first entity and the second entity.

### COPYRIGHT AND TRADEMARK NOTICES

A portion of the disclosure of this patent document contains material which is subject to copyright protection. The owner has no objection to the facsimile reproduction by any one of the patent document or the patent disclosure as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### TECHNICAL FIELD

The present invention relates generally to a network of associated entities and, more particularly, to systems and methods for monitoring or evaluating the strength of associations between such entities.

### BACKGROUND

The analysis of the nature of relationships and associations between various entities in different networks or groups is the subject of many socio-economical studies. The results of such studies can be used to determine behavioral habits and activity patterns for the involved entities and groups. To be efficient and effective, studies conducted in real world environments are generally limited to certain target groups and sample subjects within each group. With the advent of virtual worlds (i.e., computer generated graphical environments), many social groups and relationships in the real world may be successfully implemented.

For example, entities can be represented by avatars (i.e., software generated agents) in virtual environments, typically in the form of graphically rendered images, icons, characters or other visual manifestations of controllable objects (e.g., graphically presentable life forms). Such virtual worlds may be used to analyze real world relationships and associations in more manageable ways. Currently, however, no systems or methods are available that can monitor the association between avatars in a virtual environment and the counterpart entities in the real world in a truly meaningful way.

Methods and systems are needed that can overcome the above problems.

### SUMMARY

The present disclosure is directed to systems, methods and corresponding products that facilitate monitoring or evaluating the strength of associations between entities or groups in a network.

For purposes of summarizing, certain aspects, advantages, and novel features of the invention have been described herein. It is to be understood that not all such advantages may be achieved in accordance with any one particular embodiment of the invention. Thus, the invention may be embodied or carried out in a manner that achieves or optimizes one advantage or group of advantages without achieving all advantages as may be taught or suggested herein.

In accordance with one embodiment, a method for monitoring associations between a plurality of entities comprises representing a relationship between a first entity and a second entity as an edge that connects a first node to a second node, wherein the first node and the second node respectively represent said first entity and said second entity; and assigning a weight to said edge based on an association level detected between the first entity and the second entity.

The association level and type may be determined based on various factors such as the level of activity or communication between the first and second entities, the number of common resources or objects available to both the first entity and the second entity, the number of common environments or groups visited or joined by both entities, the number of related objects associated with both entities, or the number of related activities and environments in which the entities participate.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary virtual environment in accordance with one or more embodiments, wherein interactions between a plurality of entities are monitored.

FIG. 2 is a flow diagram of a method for monitoring interactions between a plurality of entities, in accordance with one embodiment.

FIGS. 3 and 4 and are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF THE EXEMPLARY EMBODIMENTS

The present disclosure is directed to systems and corresponding methods that facilitate monitoring interaction between a plurality of entities. For each entity, data is collected about the entity's interactions with other entities. A network of connected nodes is maintained based on a detected association between said entities, wherein each node represents an entity and the weight of an edge connecting two nodes represents the level of interaction between those nodes.

In the following, numerous specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

In accordance with one aspect of the invention, a network may be implemented as a structure that defines the association of entities or groups in relation to each other. Nodes in the graph may be used to represent entities such as locations, organizations, peoples, groups and their roles or attributes. Edges may be used to connect the nodes together to indicate an association or a relationship between the connected nodes. Strength of the connection between the nodes may be represented by a value (e.g., a weight) and possibly a tupe assigned to the respective edge.

In accordance with one embodiment, a method for monitoring associations between a plurality of entities in a network comprises representing a relationship between a first entity and a second entity as an edge that connects a first node to a second node, wherein the first node and the second node respectively represent said first entity and said second entity; and assigning a weight value and possibly a type to said edge based on an association level detected between the first entity and the second entity. As an alternative to setting multiple values for multiple types, the same information may be encoded as a vector of values for the edge.

The association level may be determined based on various factors such as the level of activity or communication between the first and second entities, the number of common resources or objects available to both the first entity and the second entity, the number of common environments or groups visited or joined by both entities, the number of related objects associated with both entities, or the number of related activities and environments in which the entities participate. The edge weights may also provide an association type, such that one weight may provide a measure of friendship, dislike or business collaboration between two entities, for example.

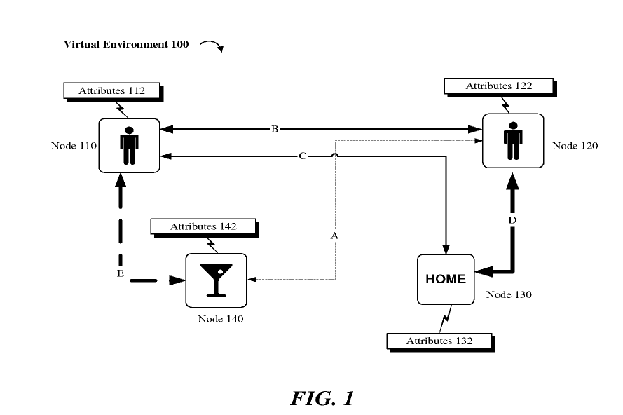

The monitored entities or environments may be either virtual or real, depending on implementation. Referring to FIG. 1, an exemplary virtual environment 100 is illustrated. The virtual environment may be implemented using logic code (e.g., software) loaded onto one or more computing systems connected by way of an electronic communication network (e.g., the Internet). In accordance with one aspect of the system, the virtual environment 100 supports an environment in which one or more software applications can be executed on top of one or more operating systems to instantiate or create virtual objects that represent a node in the virtual environment 100.

As shown in FIG. 1, nodes 110 through 140 represent different entities in virtual environment 100. For example, node 110 may represent a male participant in a social network, while node 120 may represent a female participant. A node may be also assigned certain attributes. Nodes 110 and 120 may, for example, be assigned attributes 112 and 122 respectively. The attributes may provide detailed information about each node, such as name, location, information about the associated nodes, and any other details available for the node.

A node's information may be used by simulators, scripts, and objects to track an entity's location, activities and interactions with other entities. For example, the activities of entities represented by nodes 110 and 120 may be tracked to determine whether an association may be established in the form of an edge between nodes 110 and 120. An edge may represent, for example, a social interaction, a business relationship or a commercial activity between the entities in the network.

In an exemplary scenario, the entities represented by nodes 110 and 120 may have visited an entity or establishment (e.g., a restaurant) represented by node 140. The association with node 140 may be represented by an edge A connecting nodes 140 and 120, and an edge E connecting nodes 140 and 110. In some embodiments, an additional edge B may connect nodes 110 and 120 as a representation that nodes 110 and 120 have a common interest in node 140 (e.g., they have both visited a common entity).

In another embodiment, edge B may represent that the entities represented by nodes 110 and 120 may have met at a location represented by node 140, or alternatively that they didn't meet but were at a certain location at the same time, for example, or that they have expressed a common interest in said location by joining a group associated with that location, etc. One can appreciate that other types of associations and relationships may be also represented by edges connecting different nodes. For example, an edge between node 120 and node 130 may represent that the entity represented by node 120 owns the entity (e.g., house) represented by node 130.

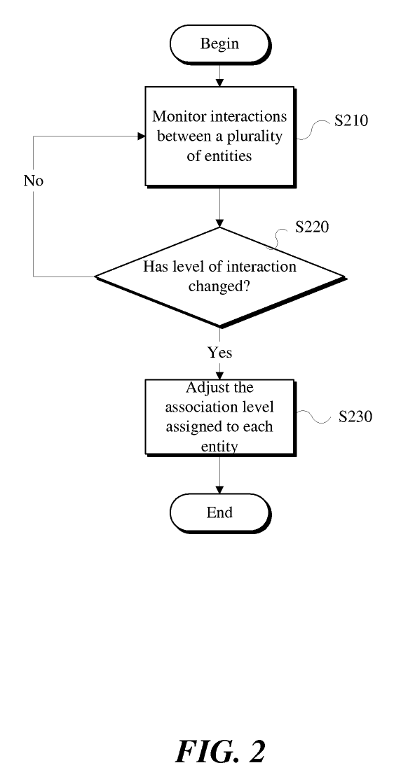

Referring to FIGS. 1 and 2, in certain embodiments, level of interaction between the entities is monitored (S210). Depending on the level of interaction, a certain weight may be assigned to an edge representing an association between two nodes. For example, as shown in FIG. 1, edge E connecting nodes 110 and 140 has a greater weight than edge A connecting nodes 120 and 140 to indicate that, for example, the entity represented by node 110 has visited location represented by node 140 more frequently than the entity represented by node 120. Similarly, edge D has a greater weight than edge C, indicating for example that the entity represented by node 120 more frequently visits location represented by node 130, than entity represented by node 110.

Referring back to FIG. 2, if it is determined that the level of interaction between two nodes has changed (S220), the association level or the strength of a relationship between two nodes (e.g., represented by the weight of an edge connecting the two nodes) may be adjusted (S230). For example, as shown in FIG. 1, if the entity represented by node 110 does not visit the entity represented by node 120 (at node 130 representing, for example, a house owned by node 120), as frequently, then the weight of edge C connecting node 110 to node 130 may be reduced. If the level of inactivity between nodes 110 and 130 (or nodes 110 and 120) continues or is prolonged beyond a threshold, then edge C may be completely removed.

Depending on implementation, a history of the level of activity for one node or the level of interaction between the nodes may be stored in a database either separately or, for example, as a part of the attributes associated with each node. Accordingly, it would be possible to analyze the activity level of a node or interactivity level between multiple nodes throughout a certain time period. That is, the data stored for each node, desirably including the node's attributes, along with the association between the nodes and the strength of each association can be tracked in time to discern habits and patterns of activity for various nodes or their corresponding entities, groups or establishments represented by other nodes.

In some embodiments, a social networking graph may be generated by special software applications configured to collect data about one or more nodes, using various social network mining tools. For example, presence of a new entity may be detected when a corresponding node is added to the social network. As discussed earlier, if two entities either visit the same location, spend time in the same location, participate in the same type of activity, chat with each other, or the like, the software application causes the weight of the corresponding edges in the social network to be increased.

In some embodiments, data may be collected and analyzed using existing social network mining tools or a standard web log analyzer. The data may be then used to determine best means for product placement at a certain location, the number of visitors, the best time of day or week for such placement, or the number of visitors who come back within a certain time threshold to visit the same location.

The location and identity of an entity may be continuously monitored to determine certain habits or patterns for the particular entity. In some embodiments, the monitoring comprises tracking the locations visited by each entity by way of, for example, logging that entity's identification information in association with the visited location. Based on the recorded data a periodic report may be generated to report the type and level of activity by an entity, the entities associated with a target entity, the type and level of interaction between certain entities, etc.

Depending on implementation and types of data analysis and data mining tools utilized, various statistics may be generated based on the recorded data and the reports. The statistics based on that activity may include time of day distribution, day of week distribution, visit duration, or number of repeat visits. In some embodiments, to avoid over logging or over analysis, multiple logs referring to the same identification information for an entity during a certain time frame (e.g., a short time line) may be construed as a single visit.

In some embodiments, a presence map may be generated based on detected level of activity for one or more entities in a certain location; generating statistical reports based on the level of activity. A map may be also generated based on said statistics. Color coding schemes may be used to designate high/low presence or high/low traffic locations based on the level of activity, the type of activity, or other statistical factors that may be important to a researcher or analyst.

The color coding scheme may be utilized to represent, for example, the number of entities or the amount of time a particular entity spends in one or more locations, such that the intensity of a color or a mark is increased or decreased according to an increase or decrease in the number of entities or the duration of their stay in a certain location. Similar or other types of coding or identification schemes may be used to represent locations which attract visitors for particular time durations.

In one embodiment, the tools, schemes and patterns discussed above with reference to a virtual environment 100 may be utilized and applied to a real world environment, where certain interactions and activities by certain individuals may be monitored. For example, a real life office environment is very similar to a virtual environment, from a simulation or verification standpoint, and therefore can be monitored in accordance with the same schemes and concepts disclosed earlier.

By way of example, individuals working in an office interact and associate with members of a particular social network (i.e., employees of an enterprise) according to a set of rules (i.e., work etiquette and office rules). Such individuals are also typically confined within structural limitations (i.e., office space) and interface via specific means of communication (e.g., electronic networks, email, telephone, etc.) according to a predefined time schedule. Thus, many activities or interactivities of each individual can be taken into account based on the content of the individual's communication (e.g., email correspondence) with others. The time and location of certain activities may be also monitored.

Accordingly, each individual noted above may be represented by a node; one or more edges can be used to define that individual's associations (and the strength of each association) with other individuals or entities in the social network. Similar interests among individuals can be determined based on the content of their communication, the type of content they access (e.g., over the internet), or the files that they own or share over a communication network. As such, it can be seen that the conceptual schemes discussed with respect to a virtual environment may be equally applied to real-life subjects. It is noteworthy of course, that one or more embodiments may be implemented within the confines of the law as related to individual privacy rights and subject to the consent of the individuals involved where appropriate.

In different embodiments, the invention can be implemented either entirely in the form of hardware or entirely in the form of software, or a combination of both hardware and software elements. For example software utilized to implement one or more aspects of the above system may comprise a controlled computing system environment that can be presented largely in terms of hardware components and software code executed to perform processes that achieve the results contemplated by the system of the present invention.

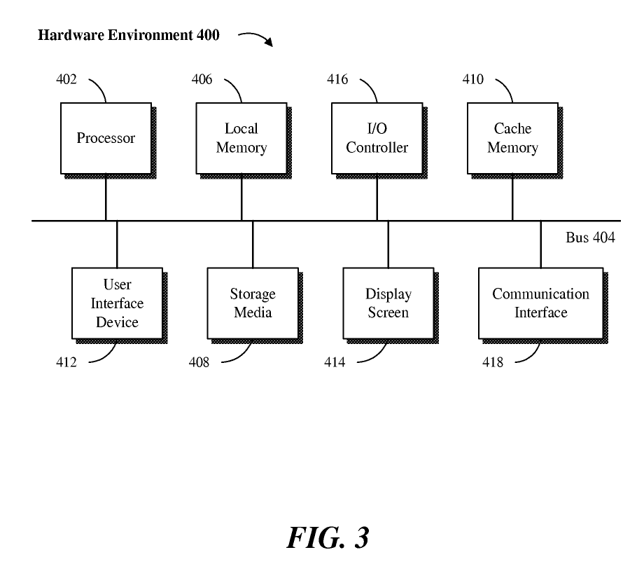

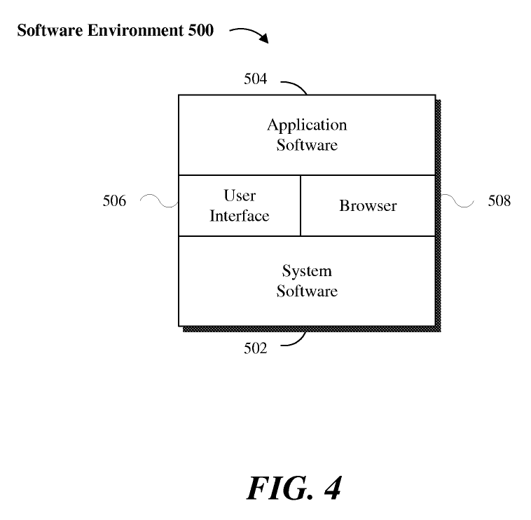

Referring to FIGS. 3 and 4, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 502 and application software 504. System software 502 comprises control programs, such as the operating system (OS) and information management systems that instruct the hardware how to function and process information.

In one embodiment, software for implementing the novel concepts discussed here may be implemented as system software 502 and application software 504 executed on one or more hardware environments to facilitate memory sharing among computing systems in network 130. Application software 504 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 3, an embodiment of the system software 502 and application software 504 can be implemented as computer software in the form of computer readable code executed on a data processing system such as hardware environment 400 that comprises a processor 402 coupled to one or more computer readable media or memory elements by way of a system bus 404. The computer readable media or the memory elements, for example, can comprise local memory 406, storage media 408, and cache memory 410. Processor 402 loads executable code from storage media 408 to local memory 406. Cache memory 410 provides temporary storage to reduce the number of times code is loaded from storage media 408 for execution.

A user interface device 412 (e.g., keyboard, pointing device, etc.) and a display screen 414 can be coupled to the computing system either directly or through an intervening I/O controller 416, for example. A communication interface unit 418, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 400 may not include all the above components, or may comprise other components for additional functionality or utility. For example, hardware environment 400 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 4, system software 502 and application software 504 can comprise one or more computer programs that are executed on top of operating system 112 after being loaded from storage media 408 into local memory 406. In a client-server architecture, application software 504 may comprise client software and server software. For example, in one embodiment of the invention, client software is executed on computing systems 110 or 120 and server software is executed on a server system (not shown).

Software environment 500 may also comprise browser software 508 for accessing data available over local or remote computing networks. Further, software environment 500 may comprise a user interface 506 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method comprising:
representing a relationship between a first entity and a second entity as an edge that connects a first node to a second node, wherein the first node and the second node respectively represent said first entity and said second entity; and
assigning a weight value or type to said edge based on an association level detected between the first entity and the second entity.

2. The method of claim 1, wherein the association level is determined based on level of activity between the first and second entities.

3. The method of claim 1, wherein the level of activity is determined based on level of communication between the first and second entities.

4. The method of claim 1, wherein the association level is determined based on number of common resources available to both the first entity and the second entity.

5. The method of claim 1, wherein the association level is determined based on number of common objects associated with both the first entity and the second entity.

6. The method of claim 1, wherein the association level is determined based on number of common environments visited by both the first entity and the second entity.

7. The method of claim 1, wherein the association level is determined based on number of common groups joined by both the first entity and the second entity.

8. The method of claim 1, wherein the association level is determined based on number of related objects associated with both the first entity and the second entity.

9. The method of claim 1, wherein the association level is determined based on number of related activities in which both the first entity and the second entity participate.

10. The method of claim 1, wherein the association level is determined based on number of related environments which both the first entity and the second entity visit.

11. A system comprising:
logic unit to represent a relationship between a first entity and a second entity as an edge that connects a first node to a second node, wherein the first node and the second node respectively represent said first entity and said second entity; and
logic unit to assign a weight value or type to said edge based on an association level detected between the first entity and the second entity.

12. The system of claim 11, wherein the association level is determined based on level of activity between the first and second entities.

13. The system of claim 11, wherein the level of activity is determined based on level of communication between the first and second entities.

14. The system of claim 11, wherein the association level is determined based on number of common resources available to both the first entity and the second entity.

15. The system of claim 11, wherein the association level is determined based on number of common objects associated with both the first entity and the second entity.

16. A computer usable storage medium with logic code stored thereon, wherein execution of the logic code by a microcontroller causes a computing system to:
represent a relationship between a first entity and a second entity as an edge that connects a first node to a second node, wherein the first node and the second node respectively represent said first entity and said second entity; and
assign a weight value or type to said edge based on an association level detected between the first entity and the second entity.

17. The computer usable storage medium of claim 16, wherein the association level is determined based on level of activity between the first and second entities.

18. The computer usable storage medium of claim 16, wherein the level of activity is determined based on level of communication between the first and second entities.

19. The computer usable storage medium of claim 16, wherein the association level is determined based on number of common resources available to both the first entity and the second entity.

20. The computer usable storage medium of claim 16, wherein the association level is determined based on number of common objects associated with both the first entity and the second entity.
